(19) United States
(12) Patent Application Publication
(10) Pub. No.: US 2018/0196810 A1
(43) Pub. Date: Jul. 12, 2018

(54) Interactive Columbarium Park and Method of Constructing the Same

(71) Applicant: John Paul Pham, Grand Prairie, TX (US)

(72) Inventor: John Paul Pham, Grand Prairie, TX (US)

(21) Appl. No.: 15/864,987

(22) Filed: Jan. 8, 2018

Related U.S. Application Data
(60) Provisional application No. 62/443,069, filed on Jan. 6, 2017.

(51) Int. Cl. G06F 17/30

(52) U.S. Cl. CPC G06F 17/30041; G06F 3/147; G06F 17/3005; G06F 17/30867

(57) ABSTRACT

An interactive columbarium park is provided. has a master server, a slave server, a niche and a code. The master server and the slave server are electrically connected with each other and are configured to receive a number entered by a user. The niche is configured to store ashes or items of a deceased entity. The code is assigned to the niche, is stored in the master server, and is configured to be compared with the number entered by the user. A method of constructing the interactive columbarium park is provided.

The current application claims a priority to the U.S. Provisional Patent application Ser. No. 62/443,069 filed on Jan. 6, 2017.

### FIELD OF THE INVENTION

The present invention relates generally to a columbarium park and a method of constructing the columbarium park. More particularly, the present invention relates to an interactive, state-of-the-art indoor/outdoor columbarium memorial park which keeps cremation ashes or small personal items for the memory of a deceased entity, and relates to a method of constructing the interactive columbarium park.

### BACKGROUND OF THE INVENTION

A traditional columbarium park is a place for the respectful and usually public storage of cinerary urns that hold a deceased entity's cremated remains. The traditional columbarium park typically has a bounded area and multiple niches placed in the bounded area. People simply go to traditional columbarium parks to put the deceased entity's cremated remains into the niches and remember their deceased entities. However, traditional columbarium parks do not have any function of interacting with loved ones and/or the public.

It is therefore an objective of the present invention to provide an interactive columbarium park that is able to interact with loved ones and/or the public, such that loved ones and/or the public could view a file containing personalized video/audio/slideshow/image of a deceased entity's history that is broadcasted via connected servers and displaying devices abundantly distributed throughout the interactive columbarium park by entering any number to comply with a code associated with a niche which stores ashes or items of the deceased entity. It is therefore an objective of the present invention to provide a method of constructing the interactive columbarium park

### BRIEF DESCRIPTION OF THE DRAWINGS

FIG. 1 is a diagram depicting components of an interactive columbarium park according to an embodiment of the present invention.

FIG. 2 is a diagram depicting electrical connection between the components of the interactive columbarium park according to an embodiment of the present invention.

FIG. 3 is a diagram depicting a file and a code received by a server according to an embodiment of the present invention.

FIG. 4 is a flow chart depicting providing a master server, a slave server, a displaying device, a niche, a code and a file for the interactive columbarium park according to an embodiment of the present invention.

FIG. 5 is a flow chart depicting providing a camera for the interactive columbarium park according to an embodiment of the present invention.

FIG. 6 is a flow chart depicting providing a solar system for the interactive columbarium park according to an embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

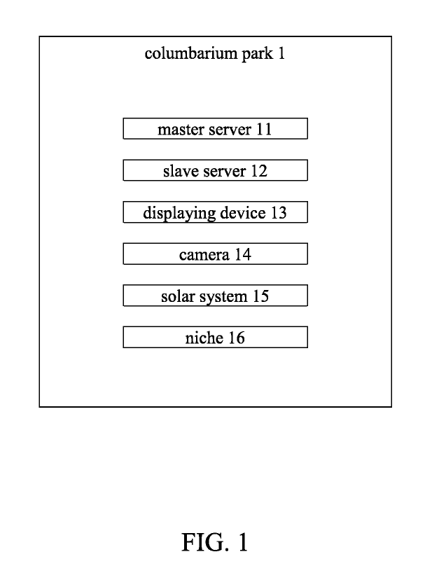

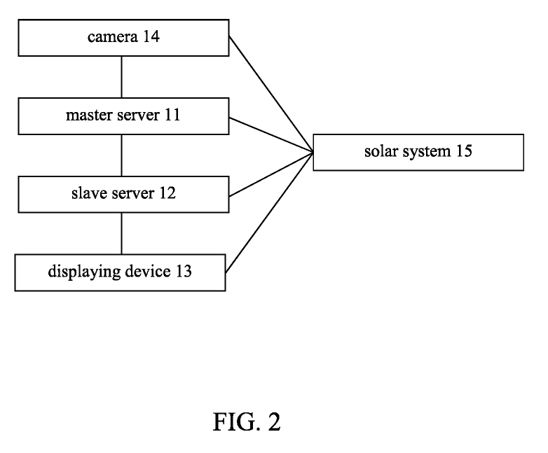

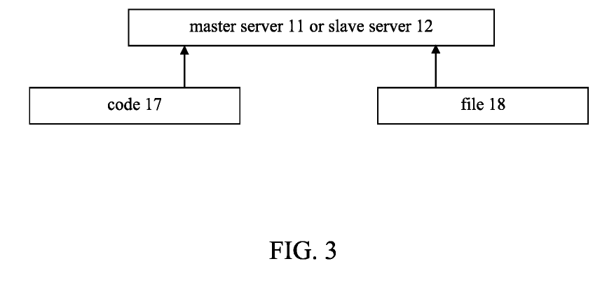

Please refer to FIGS. 1-3, the present invention provides an interactive columbarium park 1. The interactive columbarium park 1 comprises a master server 11, a slave server 12, a niche 16 and a code 17.

The master server 11 and the slave server 12 are electrically connected with each other. The master server 11 and the slave server 12 are wirelessly connected with each other. The slave server 12 is positioned in a vicinity of the niche 16. The master server 11 and the slave server 12 each is configured to receive a number entered by a user.

The niche 16 is configured to store ashes or items of a deceased entity. The deceased entity is a human being or a pet.

The code 17 is assigned to the niche 16. The code 17 is stored in the master server 11. The code 17 is configured to be compared with the number entered by the user.

In one embodiment, the interactive columbarium park 1 further comprises a displaying device 13, such as a plasma screen or an individual tablet. The displaying device 13 and the slave server 12 are electrically connected with each other. The displaying device 13 and the slave server 12 are wirelessly connected with each other. The displaying device 13 is positioned in a vicinity of the niche 16. The displaying device 13 and the slave server 12 is integrated together to form one apparatus with displaying and server functions.

In one embodiment, the displaying device 13 is brought by the user who arrives the interactive columbarium park 1. When the user arrives the interactive columbarium park 1, the user simply provides the displaying device 13, such as a smartphone, and connects it to the slave server 12 via wireless.

In one embodiment, the interactive columbarium park 1 further comprises a file 18. The file 18 and the code 17 are associated with each other. The file 18 a compilation of a history information of the deceased entity. For example, the file 18 is a personalized video/audio/slideshow/image of the deceased entity. The file 18 is initially stored in the master server 11 or initially stored in the slave server 12.

In one embodiment, the file 18 is brought by the user who arrives the interactive columbarium park 1. When the user arrives the interactive columbarium park 1, the user simply uploads the file 18 from a personal storage unit, such as a USB device, to the master server 11 or the slave server 12. Alternatively, the user remotely transfers the file 18 from a personal computer to the master server 11 or the slave server 12 via Networks.

In one embodiment, when the number entered by the user is received by the slave server 12 and is transferred to the master server 11, the master server 11 is configured to compare the number entered by the user which is transferred to the master server 11 with the code 17 which is stored in the master server 11.

In the embodiment, when the number entered by the user is received by the slave server and is transferred to the master server 11, the master server 11 is configured to compare the number entered by the user with the code 17. When the master server 11 determines that the number entered by the user complies with the code 17, the file 18 is displayed. When the master server 11 determines that the number entered by the user does not comply with the code 17, the file 18 will not displayed.

In one aspect, the file 18 is initially stored in, or is uploaded to, the master server 11. When the master server 11 determines that the number entered by the user complies with the code 17, the file 18 is transferred from the master server 11 through the slave server 12 to the displaying device 13. When the file 18 is transferred to the displaying device 13, the file 18 is displayed on the displaying device 13.

In one aspect, the file 18 is initially stored in, or is uploaded to, the slave server 12. When the master server 11 determines that the number entered by the user complies with the code 17, the file 18 is transferred from the slave server 12 to the displaying device 13. When the file 18 is transferred to the displaying device 13, the file 18 is displayed on the displaying device 13.

In one embodiment, when the number entered by the user is received by the slave server 12 and the code 17 is transferred from the master server 11 to the slave server, the slave server 12 is configured to compare the number entered by the user which is received by the slave server 12 with the code 17 which is transferred to the slave server.

In the embodiment, when the number entered by the user is received by the slave server 12 and the code 17 is transferred to the slave server 12, the slave server 12 is configured to compare the number entered by the user with the code 17. When the slave server 12 determines that the number entered by the user complies with the code 17, the file 18 is displayed. When the slave server 12 determines that the number entered by the user does not comply with the code 17, the file 18 will not displayed.

In one aspect, the file 18 is initially stored in, or is uploaded to, the master server 11. When the slave server 12 determines that the number entered by the user complies with the code 17, the file 18 is transferred from the master server 11 through the slave server 12 to the displaying device 13. When the file 18 is transferred to the displaying device 13, the file 18 is displayed on the displaying device 13.

In one aspect, the file 18 is initially stored in, or is uploaded to, the slave server 12. When the slave server 12 determines that the number entered by the user complies with the code 17, the file 18 is transferred from the slave server 12 to the displaying device 13. When the file 18 is transferred to the displaying device 13, the file 18 is displayed on the displaying device 13.

In one embodiment, the interactive columbarium park 1 further comprises a camera 14. The camera 14 and the master server 11 are electrically connected with each other. The camera 14 and the master server 11 are wirelessly connected with each other.

When the number entered by the user is received by the master server 11, the camera 14 is configured to be accessed by the user. The camera 14 is positioned in a vicinity of the niche 16. The camera 14 is used as a means of security and further allows loved ones and/or the public to view a park ceremony at that moment when requested for live-streaming.

In one embodiment, the interactive columbarium park 1 further comprises a solar system 15. The master server 11, the slave server 12, the displaying device 13, the camera 14 and the solar system 15 are electrically connected with one another. The solar system 15 is used to provide power source, to provide energy to the interactive columbarium park 1 as well as to sell back to power grids.

In another embodiment, the master server 11 and the slave server 12 are wiredly connected with each other. In a further embodiment, the wireless connection and the wired connection is implemented simultaneously, i.e., the master server 11 and the slave server 12 are wirelessly and wiredly connected with each other.

In another embodiment, the slave server 12 is not positioned in the vicinity of the niche 16.

In another embodiment, the interactive columbarium park 1 comprises a plurality of slave servers 12. The plurality of slave servers 12 are distributed throughout an area of the interactive columbarium park 1. Each of the plurality of slave servers 12 is electrically, wirelessly and/or wiredly, connected with the master server 11. The user chooses any of the plurality of slave servers 12 to enter the number.

In another embodiment, the interactive columbarium park 1 comprises a plurality of niches 16. The plurality of niches 16 are configured to store cremation ashes or items of a plurality of deceased entities.

In another embodiment, the interactive columbarium park 1 comprises a plurality of codes 17. A specific code 17 among the plurality of codes 17 is assigned to a corresponding niche 16 among the plurality of niches 16. The plurality of codes 17 are stored in the master server 11. Each of the plurality of codes 17 is configured to be compared with the number entered by the user.

In another embodiment, the displaying device 13 and the slave server 12 are wiredly connected with each other. In a further embodiment, the displaying device 13 and the slave server 12 are wirelessly and wiredly connected with each other.

In another embodiment, the displaying device 13 is not positioned in the vicinity of the niche 16.

In another embodiment, the displaying device 13 and the slave server 12 is not integrated together.

In another embodiment, the interactive columbarium park 1 comprises a plurality of displaying devices 13. The plurality of displaying devices 13 are distributed throughout the area of the interactive columbarium park 1.

In another embodiment, when the user arrives the interactive columbarium park 1, the user provides the displaying device 13 and connects it to the slave server 12 via wired connection.

In another embodiment, the interactive columbarium park 1 comprises a plurality of files 18 from the plurality of deceased entities. A specific file 18 among the plurality of files 18 is associated with a corresponding code 17 among the plurality of codes 17.

In another embodiment, the camera 14 and the master server 11 are wiredly connected with each other. In a further embodiment, the camera 14 and the master server 11 are wirelessly and wiredly connected with each other.

In another embodiment, the interactive columbarium park 1 comprises a plurality of cameras 14. The plurality of cameras 14 distributed throughout the area of the interactive columbarium park 1. Each of the plurality of cameras 14 is electrically, wirelessly and/or wiredly, connected with the master server 11.

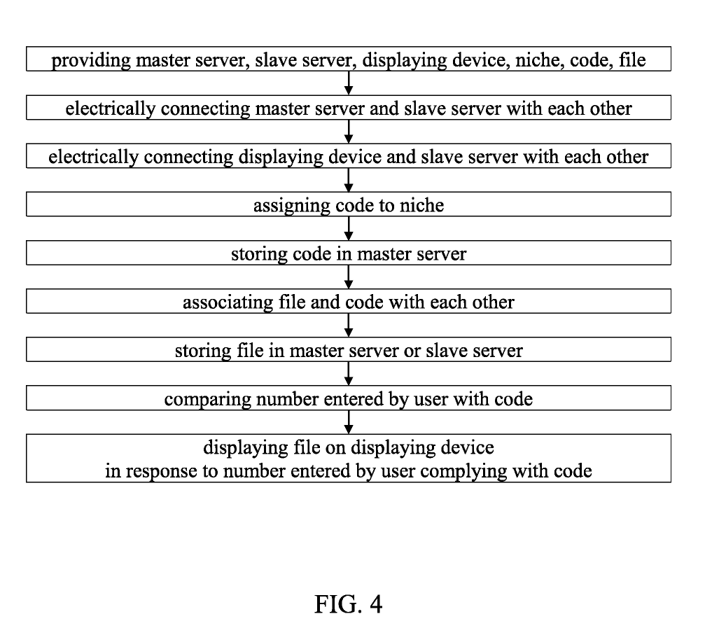

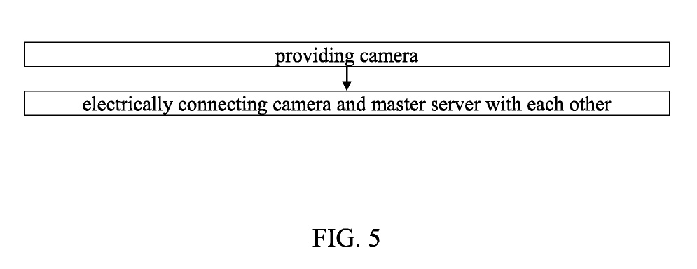

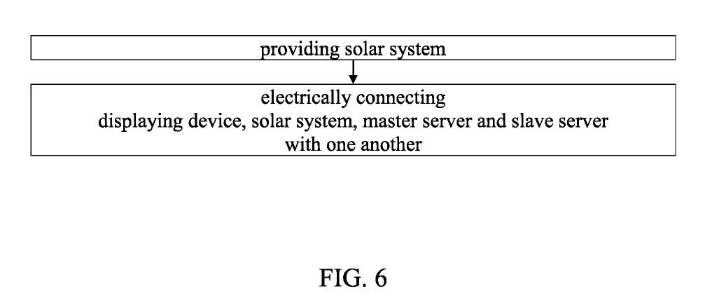

Please refer to FIGS. 4-6, the present invention provides a method of constructing the interactive columbarium park 1.

The method of constructing the interactive columbarium park 1 comprises provides the master server 11, the slave server 12, the niche 16 and the code 17.

The master server 11 and the slave server 12 are electrically connected with each other. The master server 11 and the slave server 12 are wirelessly connected with each other. The slave server 12 is positioned in the vicinity of the niche 16. The master server 11 and the slave server 12 each is configured to receive the number entered by the user.

The niche 16 is configured to store the ashes or items of the deceased entity. The deceased entity is the human being or the pet.

The code 17 is assigned to the niche 16. The code 17 is stored in the master server 11. The code 17 is configured to be compared with the number entered by the user. In one embodiment, the method of constructing the interactive columbarium park 1 further comprises providing the displaying device 13, such as the plasma screen or the individual tablet. The displaying device 13 and the slave server 12 are electrically connected with each other. The displaying device 13 and the slave server 12 are wirelessly connected with each other. The displaying device 13 is positioned in the vicinity of the niche 16. The displaying device 13 and the slave server 12 is integrated together to form one apparatus with displaying and server functions.

In one embodiment, the displaying device 13 is brought by the user who arrives the interactive columbarium park 1. When the user arrives the interactive columbarium park 1, the user simply provides the displaying device 13, such as the smartphone, and connects it to the slave server 12 via wireless.

In one embodiment, the method of constructing the interactive columbarium park 1 further comprises providing the file 18. The file 18 and the code 17 are associated with each other. The file 18 the compilation of the history information of the deceased entity. For example, the file 18 is the personalized video/audio/slideshow/image of the deceased entity. The file 18 is initially stored in the master server 11 or initially stored in the slave server 12.

In one embodiment, the file 18 is brought by the user who arrives the interactive columbarium park 1. When the user arrives the interactive columbarium park 1, the user simply uploads the file 18 from the personal storage unit, such as the USB device, to the master server 11 or the slave server 12. Alternatively, the user remotely transfers the file 18 from the personal computer to the master server 11 or the slave server 12 via Networks.

In one embodiment, when the number entered by the user is received by the slave server 12 and is transferred to the master server 11, the master server 11 is configured to compare the number entered by the user which is transferred to the master server 11 with the code 17 which is stored in the master server 11.

In the embodiment, when the number entered by the user is received by the slave server and is transferred to the master server 11, the master server 11 is configured to compare the number entered by the user with the code 17. When the master server 11 determines that the number entered by the user complies with the code 17, the file 18 is displayed. When the master server 11 determines that the number entered by the user does not comply with the code 17, the file 18 will not displayed.

In one aspect, the file 18 is initially stored in, or is uploaded to, the master server 11. When the master server 11 determines that the number entered by the user complies with the code 17, the file 18 is transferred from the master server 11 through the slave server 12 to the displaying device 13. When the file 18 is transferred to the displaying device 13, the file 18 is displayed on the displaying device 13.

In one aspect, the file 18 is initially stored in, or is uploaded to, the slave server 12. When the master server 11 determines that the number entered by the user complies with the code 17, the file 18 is transferred from the slave server 12 to the displaying device 13. When the file 18 is transferred to the displaying device 13, the file 18 is displayed on the displaying device 13.

In one embodiment, when the number entered by the user is received by the slave server 12 and the code 17 is transferred from the master server 11 to the slave server, the slave server 12 is configured to compare the number entered by the user which is received by the slave server 12 with the code 17 which is transferred to the slave server.

In the embodiment, when the number entered by the user is received by the slave server 12 and the code 17 is transferred to the slave server 12, the slave server 12 is configured to compare the number entered by the user with the code 17. When the slave server 12 determines that the number entered by the user complies with the code 17, the file 18 is displayed. When the slave server 12 determines that the number entered by the user does not comply with the code 17, the file 18 will not displayed.

In one aspect, the file 18 is initially stored in, or is uploaded to, the master server 11. When the slave server 12 determines that the number entered by the user complies with the code 17, the file 18 is transferred from the master server 11 through the slave server 12 to the displaying device 13. When the file 18 is transferred to the displaying device 13, the file 18 is displayed on the displaying device 13.

In one aspect, the file 18 is initially stored in, or is uploaded to, the slave server 12. When the slave server 12 determines that the number entered by the user complies with the code 17, the file 18 is transferred from the slave server 12 to the displaying device 13. When the file 18 is transferred to the displaying device 13, the file 18 is displayed on the displaying device 13.

In one embodiment, the method of constructing the interactive columbarium park 1 further comprises providing the camera 14. The camera 14 and the master server 11 are electrically connected with each other. The camera 14 and the master server 11 are wirelessly connected with each other. When the number entered by the user is received by the master server 11, the camera 14 is configured to be accessed by the user. The camera 14 is positioned in a vicinity of the niche 16. The camera 14 is used as a means of security and further allows loved ones and/or the public to view the park ceremony at that moment when requested for live-streaming.

In one embodiment, the method of constructing the interactive columbarium park 1 further comprises providing the solar system 15. The master server 11, the slave server 12, the displaying device 13, the camera 14 and the solar system 15 are electrically connected with one another. The solar system 15 is used to provide power source, to provide energy to the interactive columbarium park 1 as well as to sell back to power grids.

In another embodiment, the master server 11 and the slave server 12 are wiredly connected with each other. In a further embodiment, the wireless connection and the wired connection is implemented simultaneously, i.e., the master server 11 and the slave server 12 are wirelessly and wiredly connected with each other.

In another embodiment, the slave server 12 is not positioned in the vicinity of the niche 16.

In another embodiment, the method of constructing the interactive columbarium park 1 comprises providing the plurality of slave servers 12. The plurality of slave servers 12 are distributed throughout an area of the interactive columbarium park 1. Each of the plurality of slave servers 12 is electrically, wirelessly and/or wiredly, connected with the master server 11. The user chooses any of the plurality of slave servers 12 to enter the number.

In another embodiment, the method of constructing the interactive columbarium park 1 comprises providing the plurality of niches 16. The plurality of niches 16 are configured to store cremation ashes or items of a plurality of deceased entities.

In another embodiment, the method of constructing the interactive columbarium park 1 comprises providing the plurality of codes 17. A specific code 17 among the plurality of codes 17 is assigned to a corresponding niche 16 among the plurality of niches 16. The plurality of codes 17 are stored in the master server 11. Each of the plurality of codes 17 is configured to be compared with the number entered by the user.

In another embodiment, the displaying device 13 and the slave server 12 are wiredly connected with each other. In a further embodiment, the displaying device 13 and the slave server 12 are wirelessly and wiredly connected with each other.

In another embodiment, the displaying device 13 is not positioned in the vicinity of the niche 16.

In another embodiment, the displaying device 13 and the slave server 12 is not integrated together.

In another embodiment, the method of constructing the interactive columbarium park 1 comprises providing the plurality of displaying devices 13. The plurality of displaying devices 13 are distributed throughout the area of the interactive columbarium park 1.

In another embodiment, when the user arrives the interactive columbarium park 1, the user provides the displaying device 13 and connects it to the slave server 12 via wired connection.

In another embodiment, the method of constructing the interactive columbarium park 1 comprises providing the plurality of files 18 from the plurality of deceased entities. A specific file 18 among the plurality of files 18 is associated with a corresponding code 17 among the plurality of codes 17.

In another embodiment, the camera 14 and the master server 11 are wiredly connected with each other. In a further embodiment, the camera 14 and the master server 11 are wirelessly and wiredly connected with each other.

In another embodiment, the method of constructing the interactive columbarium park 1 comprises providing the plurality of cameras 14. The plurality of cameras 14 distributed throughout the area of the interactive columbarium park 1. Each of the plurality of cameras 14 is electrically, wirelessly and/or wiredly, connected with the master server 11.

The following description explains the operation of the interactive columbarium park 1.

The user, typically the family of the deceased entity, first arrives the interactive columbarium park 1, and then targets the slave server 12, or targets a specific or any slave server 12 among the plurality of slave servers 12, whether the slave server 12 near the niche 16 of the deceased entity or not. Alternatively, the user could target the displaying device 13, or a specific or any displaying device 13 among the plurality of displaying device 13, whether the displaying device 13 near the niche 16 or not, if the displaying device 13 is integrated with the slave server 12.

Subsequently, the user would enter the number into the slave server 12 or the integrated apparatus. Once the slave server 12 receives the number entered by the user, the slave server 12 would transfer the number entered by the user to the master server 11. Then the master server 11 compares the number entered by the user with the code 17. The master server 11 will determine whether the number entered by the user complies with the code 17 or not. Alternatively, once the slave server 12 receives the number entered by the user, the master server 11 would transfer the code 17 to the slave server 12. Then the slave server 12 compares the number entered by the user with the code 17. The slave server 12 will determine whether the number entered by the user complies with the code 17 or not.

Usually, the file 18, the compilation of the history information of the deceased entity, provided by the user is initially stored in the master server 11 or initially stored in the slave server 12. Alternatively, the user could upload the file 18 to the slave server 12 after arriving the interactive columbarium park 1 and targeting the slave server 12. Alternatively, the user could upload the file 18 to the master server 11 before arriving the interactive columbarium park 1.

If the master server 11 or the slave server 12 determines that the number entered by the user complies with the code 17, or the specific code 17 among the plurality of codes 17, the master server 11 transfers the file 18 which is associated with the code 17 and is in the master server 11 through the slave server 12 to the displaying device 13, or the slave server 12 transfers the file 18 which is associated with the code 17 and is in the slave server 12 to the displaying device 13. When the file 18 is transferred to the displaying device 13, the file 18 is displayed on the displaying device 13.

If the master server 11 or the slave server 12 determines that the number entered by the user does not comply with the code 17, or the specific code 17 among the plurality of codes 17, the file 18 will not be transferred to and displayed on the displaying device 13. Under such circumstance, the user might enter another number which could comply with the code.

In some situation, the user might not be able to arrive the interactive columbarium park 1. The user still can request for live-streaming and remotely access the camera 14 to view the park ceremony for the deceased entity. The user could target a specific camera 14 among the plurality of cameras 14 which is close to the niche 16 where the park ceremony is held.

In conclusion, the present invention provides an interactive, state-of-the-art indoor/outdoor columbarium memorial park 1 to keep cremation ashes or small personal items for the memory of the deceased entity. The interactive columbarium park 1 is designed as a botanical setting with walkways covered with solar powered panels of the solar system 15 to lessen the effects of natural elements, to provide energy to the interactive columbarium park 1 as well as to sell back to power grids. The interactive columbarium park 1 is designed and created to attract visitors and loved ones to visit as a memorial site as well as act as a tourism site. The interactive columbarium park 1 further has a general area to hold large gatherings for social meetings, picnics, or concerts in celebration of the deceased entity.

The interactive columbarium park 1 is equipped with the live cameras 14 as a means of security and allows loved ones and/or the public to view the park ceremony at that moment when requested for live-streaming. The individual niche 16 that store the ashes or personal items of the deceased entity is assigned with the code 17 that allows the file 18 containing the personalized video/audio/slideshow/image of the deceased entity's history to be broadcasted through the various connected displaying devices 13, for instance, the plasma screens or the individual tablets. Loved ones and/or the public can view the short memorial of the deceased entity throughout the interactive columbarium park 1 on any of the displaying devices 13. Through the master server 11 and the slave servers 12 connected by wireless connection, such as Wi-Fi, or wired connection, these broadcasting displaying devices 13 will be abundant throughout the interactive columbarium park 1. Any number can be entered into any slave server 12 and the file 18 that the family provides will be displayed on any displaying device 13 if the number complies with the code 17 which is associated with the niche 16. There will also be a section in the area which is dedicated to pet companions that owners may wish to cremate into ashes, acting as a pet cemetery for pet lovers. The motto of the interactive columbarium park 1 is “You Are Forever Remembered.”

Although the invention has been explained in relation to its preferred embodiment, it is to be understood that many other possible modifications and variations can be made without departing from the spirit and scope of the invention as hereinafter claimed.

What is claimed is:

1. An interactive columbarium park comprising:
a master server;
a slave server;
a niche;
a code;
the master server and the slave server being electrically connected with each other;
the master server and the slave server each being configured to receive a number entered by a user;
the niche being configured to store ashes or items of a deceased entity;
the code being assigned to the niche;
the code being stored in the master server; and
the code being configured to be compared with the number entered by the user.

2. The interactive columbarium park of claim 1 comprising:
the master server being configured to compare the number entered by the user with the code in response to the number entered by the user being received by the slave server and being transferred to the master server.

3. The interactive columbarium park of claim 1 comprising:
the slave server being configured to compare the number entered by the user with the code in response to the number entered by the user being received by the slave server and the code being transferred to the slave server.

4. The interactive columbarium park of claim 1 comprising:
a file;
the file and the code being associated with each other; and
the file being a compilation of a history information of the deceased entity.

5. The interactive columbarium park of claim 4 comprising:
the master server being configured to compare the number entered by the user with the code in response to the number entered by the user being received by the slave server and being transferred to the master server; and
the file being displayed in response to the master server determining the number entered by the user complying with the code; and
the file being not displayed in response to the master server determining the number entered by the user not complying with the code.

6. The interactive columbarium park of claim 5 comprising:
a displaying device;
the displaying device and the slave server being electrically connected with each other;
the file being initially stored in the master server;
the file being transferred from the master server through the slave server to the displaying device in response to the master server determining the number entered by the user complying with the code; and
the file being displayed on the displaying device in response to the file being transferred to the displaying device.

7. The interactive columbarium park of claim 5 comprising:
a displaying device;
the displaying device and the slave server being electrically connected with each other;
the file being initially stored in the slave server;
the file being transferred from the slave server to the displaying device in response to the master server determining the number entered by the user complying with the code; and
the file being displayed on the displaying device in response to the file being transferred to the displaying device.

8. The interactive columbarium park of claim 4 comprising:
the slave server being configured to compare the number entered by the user with the code in response to the number entered by the user being received by the slave server and the code being transferred to the slave server; and
the file being displayed in response to the slave server determining the number entered by the user complying with the code; and
the file being not displayed in response to the slave server determining the number entered by the user not complying with the code.

9. The interactive columbarium park of claim 8 comprising:
a displaying device;
the displaying device and the slave server being electrically connected with each other;
the file being initially stored in the master server;
the file being transferred from the master server through the slave server to the displaying device in response to the slave server determining the number entered by the user complying with the code; and
the file being displayed on the displaying device in response to the file being transferred to the displaying device.

10. The interactive columbarium park of claim 8 comprising:
a displaying device;
the displaying device and the slave server being electrically connected with each other;
the file being initially stored in the slave server;
the file being transferred from the slave server to the displaying device in response to the slave server determining the number entered by the user complying with the code; and
the file being displayed on the displaying device in response to the file being transferred to the displaying device.

11. A method of constructing an interactive columbarium park comprising:
providing a master server;
providing a slave server;
providing a niche;
providing a code;
electrically connecting the master server and the slave server with each other;
the master server and the slave server each being configured to receive a number entered by a user;
the niche being configured to store ashes or items of a deceased entity;
assigning the code to the niche;
storing the code in the master server; and
the code being configured to be compared with the number entered by the user.

12. The method of constructing the interactive columbarium park of claim 11 comprising:
the master server comparing the number entered by the user with the code in response to the number entered by the user being received by the slave server and being transferred to the master server.

13. The method of constructing the interactive columbarium park of claim 11 comprising:
the slave server comparing the number entered by the user with the code in response to the number entered by the user being received by the slave server and the code being transferred to the slave server.

14. The method of constructing the interactive columbarium park of claim 11 comprising:
providing a file;
associating the file and the code with each other; and
the file being a compilation of a history information of the deceased entity.

15. The method of constructing the interactive columbarium park of claim 5 comprising:
the master server comparing the number entered by the user with the code in response to the number entered by the user being received by the slave server and being transferred to the master server; and
displaying the file in response to the master server determining the number entered by the user complying with the code; and
not displaying the file in response to the master server determining the number entered by the user not complying with the code.

16. The method of constructing the interactive columbarium park of claim 14 comprising:
providing a displaying device;
electrically connecting the displaying device and the slave server with each other;
initially storing the file in the master server;
transferring the file from the master server through the slave server to the displaying device in response to the master server determining the number entered by the user complying with the code; and
displaying the file on the displaying device in response to the file being transferred to the displaying device.

17. The method of constructing the interactive columbarium park of claim 16 comprising:
providing a displaying device;
electrically connecting the displaying device and the slave server with each other;
initially storing the file in the slave server;
transferring the file from the slave server to the displaying device in response to the master server determining the number entered by the user complying with the code; and
displaying the file on the displaying device in response to the file being transferred to the displaying device.

18. The method of constructing the interactive columbarium park of claim 16 comprising:
the slave server comparing the number entered by the user with the code in response to the number entered by the user being received by the slave server and the code being transferred to the slave server; and
displaying the file in response to the slave server determining the number entered by the user complying with the code; and
not displaying the file in response to the slave server determining the number entered by the user not complying with the code.

19. The method of constructing the interactive columbarium park of claim 18 comprising:
providing a displaying device;
electrically connecting the displaying device and the slave server with each other;
initially storing the file in the master server;
transferring the file from the master server through the slave server to the displaying device in response to the slave server determining the number entered by the user complying with the code; and
displaying the file on the displaying device in response to the file being transferred to the displaying device.

20. The method of constructing the interactive columbarium park of claim 18 comprising:
providing a displaying device;
electrically connecting the displaying device and the slave server with each other;
initially storing the file in the slave server;
transferring the file from the slave server to the displaying device in response to the slave server determining the number entered by the user complying with the code; and
displaying the file on the displaying device in response to the file being transferred to the displaying device.
